(19) United States
(12) Patent Application Publication
(10) Pub. No.: US 2015/0158050 A1
(43) Pub. Date: Jun. 11, 2015

(54) PRECISION ADHESIVE APPLICATOR

(71) Applicant: Eclectic Products, Inc., Eugene, OR (US)

(72) Inventor: Michael Duane Atwell, Ball, LA (US)

(73) Assignee: Eclectic Products, Inc., Eugene, OR (US)

(21) Appl. No.: 14/097,542

(22) Filed: Dec. 5, 2013

(51) Int. Cl. B05C 17/005

(52) U.S. Cl. CPC B05C 17/00516

(57) ABSTRACT

Adhesive applicators, methods of using such applicators, and kits containing such applicators are disclosed. The adhesive applicators have an applicator tip that is attached to a cap adaptor. The cap adaptor can be attached to an opening of an adhesive container and has a conical fitting. The applicator tip can be attached to the conical fitting of the cap adaptor and has a needle. The applicator tip needle has a diameter that is selected based on the viscosity of the adhesive contained in the adhesive container. When a force is applied to the adhesive container, the applicator tip is structured to dispense a single droplet of the adhesive.

### FIELD OF THE INVENTION

This invention relates generally to applying adhesives to objects and more particularly to applying adhesives to objects with an applicator attached to an adhesive container.

### BACKGROUND

Most adhesive applicators are difficult to manage when dispensing small volumes of adhesive from adhesive containers. Such small volume dispensing is particularly important when a precise volume of the adhesive is necessary, such as in creating crafts, small wood-working, and other hobby and manufacturing-related activities of small items needing to be secured together. Conventional adhesive applicators usually dispense too large of a volume of adhesive onto the items being adhered together and excess adhesive can create a mess and negatively affect the appearance of the items being adhered together. People applying the adhesive tend to resort to using additional tools or other additional adhesive application techniques in addition to the conventional adhesive applicators to apply the correct amount of adhesive to the items being adhered together. Further, an adhesive applicator can become clogged or simply warped and unusable over multiple uses, which can lead to wasted adhesive remaining in the adhesive container after the applicator becomes unusable.

For example, crafts often require a small volume and a precise application of adhesives to various items, particularly in jewelry making, applying bows, jewels, beads, or the like to items like shoes, shirts, bags, magnets, and hair clips. People enjoy such crafts for many reasons from the creative aspects of the crafts to the ability to customize their craft items to their personal tastes. Embellishing and customizing crafts in an attractive manner are important qualities to people that create crafts. Further, people creating crafts can become frustrated if adhesive is wasted because the adhesive applicators become clogged, warped, or unusable for any reason. Therefore, adhesive applicators that are capable of precisely dispensing adhesives that maximize the usage of the adhesive in the provided adhesive containers are a desirable improvement in the art.

### SUMMARY OF THE INVENTION

An adhesive applicator has a cap adaptor and an applicator tip. The cap adaptor includes a first portion that is structured to be attached to an opening of an adhesive container and a second portion that has a conical fitting with a slight taper (e.g., a 6% taper in a standard Luer lock fitting) and an internally threaded collar. The applicator tip is structured to be attached to the conical fitting of the cap adaptor and has a needle with an internal diameter. The needle diameter is selected based on a viscosity of the adhesive that is contained in the adhesive container. The applicator tip is structured to dispense a single droplet of the adhesive upon application of a force to the adhesive container.

Methods of dispensing adhesive from an adhesive container that contains an adhesive are also disclosed. A force is applied to the adhesive container to which an adhesive applicator is attached. The adhesive applicator has a first portion that is structured to be attached to an opening of the adhesive container and a second portion that has a conical fitting with a slight taper (e.g., a 6% taper of a standard Luer lock fitting) and an internally threaded collar. The adhesive applicator also has an applicator tip that is structured to be attached to the conical fitting of the cap adaptor. The applicator tip has a needle with an internal diameter that is selected based on a viscosity of the adhesive that is contained in the adhesive container. The method causes a droplet of the adhesive to be dispensed from the adhesive container needle.

Any of the disclosed adhesive applicators can be included in a kit having one or more applicator tips. The applicator tips in such kits can be disposable and are each structured to dispense a single droplet of the adhesive upon application of a force to the adhesive container to which the applicators tips are attached. The adhesive applicator with the multiple applicator tips and the adhesive container can be packaged together as an adhesive application kit. The diameters of the applicator tips in the disclosed kits can all have the same diameters or can have different diameters.

The foregoing and other objects, features and advantages of the invention will become more readily apparent from the following detailed description of preferred embodiments of the invention, which proceeds with reference to the accompanying drawings.

### BRIEF DESCRIPTION OF THE DRAWINGS

FIG. 1 is a perspective view of an example adhesive applicator shown attached to an adhesive container, according to examples of the disclosure.

FIG. 2 is an exploded view of the adhesive applicator shown in FIG. 1.

FIG. 3 is a cross-sectional view of the adhesive applicator shown in FIG. 1.

FIG. 4 is an example adhesive application kit.

### DETAILED DESCRIPTION

Many uses of applying adhesives to various objects are focused on dispensing small amounts of the adhesive in a precise manner. Conventional adhesive applicators are unable to dispense small volumes of the adhesive and instead dispense large volumes or multiple droplets of the adhesive. Dispensing large volumes of the adhesive results in excess adhesive being applied to unintended places like other portions of the target object, a person's hands, or a working surface area and can cause such objects to become unintentionally adhered to each other and/or messy and can result in wasted adhesive to clean up. The disclosed adhesive applicators are able to precisely apply adhesives in addition to many other benefits.

The disclosed adhesive applicators are attachable to an adhesive container that contains adhesive and include a cap adaptor and an applicator tip. The adhesive applicators are removable from the adhesive containers for any reason, such as cleaning, replacement, repair, or the like. The adhesive contained in the adhesive containers can be any desirable adhesive and may include craft, wood-working, manufacturing, household-use, and other types of adhesives. The adhesive container can be any suitable container, such as a metal container that is anti-corrosive against the adhesive contained within it, or can be a plastic or rubber container. Multiple different adhesive applicators can be attachable to the same adhesive container. Similarly, the same adhesive applicator can be attachable to multiple different adhesive containers. Thus, both the adhesive applicators and the adhesive containers can be interchangeable.

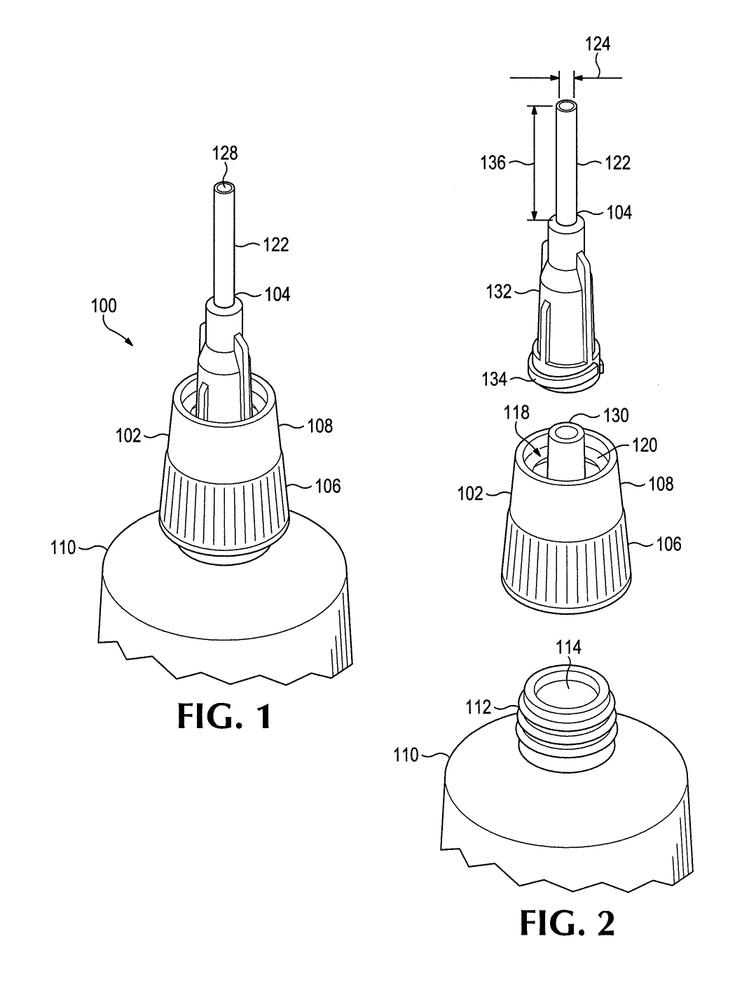

An example of the disclosed adhesive applicators is shown in FIG. 1. The adhesive applicator 100 includes a cap adaptor 102 and an applicator tip 104. The cap adaptor 102 has a first portion 106 and a second portion 108. The first portion 106 of the cap adaptor 102 is structured to be attached to an opening 114 of the adhesive container 110 and can be removable from the adhesive container 110 in some examples. The cap adaptor 102 can be attached to the adhesive container 110 by any suitable mechanical connector. In some examples, the cap adaptor 102 is made of a low density polyethylene (LDPE) or other suitable plastic material(s).

The example adhesive applicator 100 has a threaded collar 112 around the circumference of the adhesive container opening 114, as shown in FIG. 2. The first portion 106 of the cap adaptor 102 has a threaded cavity 116 that attaches to the threaded collar 112 of the adhesive opening 114 when the first portion 106 of the cap adaptor 102 is screwed on to the adhesive opening collar 112 (i.e., when the mating threads engage each other). Any other suitable mechanical connector can attach the first portion of the cap adaptor to the opening of the adhesive container.

The second portion 108 of the cap adaptor 102 has a conical fitting 118 with an internal taper and an internally threaded collar 120. The internal taper of the conical fitting 118 is a standard 6% Luer lock fitting taper, in this example. The conical fitting 118 can have a two-thread start, in some examples, and may also be structured to receive the applicator tip 104 in a Luer lock fitting. The applicator tip 104 is structured to be attached to the conical fitting 118 of the second portion 108 of the cap adaptor 102 and can be removable from the cap adaptor 102 by unscrewing the applicator tip 104 from the internally threaded collar 120 of the cap adaptor's conical fitting 118.

The applicator tip 104 also has a needle 122 having an internal diameter 124 that is selected based on a viscosity of the adhesive contained in the adhesive container 110. The needle 122 can be located on an end of the applicator tip 102 that is opposite of an end of the applicator tip 102 that attaches to the conical fitting 118 of the cap adaptor 102. When a force is applied to the adhesive container 110, the applicator tip 104 is structured to dispense a single droplet of the adhesive through the applicator needle 122. The applicator tip needle 122 is any suitable material that accommodates the adhesive and can be a stainless steel material in some examples. Suitable materials for the applicator tip needle 122 can be anti-corrosive and anti-stick to facilitate the flow of the adhesive through the applicator tip needle 122 on multiple occasions.

When the applicator tip 104 is attached to the cap adaptor 102 and the cap adaptor 102 is also connected to the opening 114 of the adhesive container 110, an adhesive pathway 126 is created between the adhesive container 110 and an exit opening 128 of the applicator tip needle 122. The adhesive pathway 126 allows the adhesive contained in the adhesive container 110 to travel from the adhesive container 110 through the cap adaptor 102 and the applicator tip 104 to be dispensed at the exit opening 128 of the applicator tip needle 122. When a force is applied to the adhesive container 110, the adhesive is pushed along the adhesive pathway 126 and is dispensed through the exit opening 128 of the applicator tip needle 122.

The applicator tip internal needle diameter 124 is selected based on a viscosity of the adhesive contained in the adhesive container 110. In some examples, the applicator tip needle diameter 124 is selected based on a maximum applied force to the adhesive container 110 that prevents detachment of the applicator tip 104 from the cap adaptor 102 when the adhesive is dispensed from the adhesive container 110 by the application of the force necessary for dispensing adhesive of a given viscosity. The Luer lock fitting between the applicator tip 104 and the cap adaptor 102 in combination with an appropriately selected internal needle diameter 124 prevents detachment of the applicator tip 104 from the cap adaptor 102 when the force is applied to the adhesive container 110 to cause the adhesive to be dispensed.

Selection of the application tip needle diameter 124 is based on the viscosity of the adhesive being dispensed. The needle diameter 124 may increase as the viscosity of the adhesive increases to permit smooth flow of the adhesive along the adhesive pathway 126 to be dispensed at the exit opening 128 of the applicator tip needle 122. As the viscosity of the adhesive increases and the needle diameter 124 correspondingly increases, the force needed to be applied to the adhesive container 110 to dispense a single droplet of the adhesive from the applicator tip 104 may vary. The force, however, does not cause the applicator tip 104 to detach from the cap adaptor 102 or the cap adaptor 102 to detach from the adhesive container opening 114. Therefore, the applicator tip needle diameter 124 is selected both to withstand the applied force necessary to dispense the single droplet of adhesive from the applicator tip needle 122 and to prevent detachment of the applicator tip 104 from the cap adaptor 102 and detachment of the cap adaptor 102 from the adhesive container 110.

The applicator tip needle diameter is selected based on the viscosity of the adhesive to be dispensed. If the selected internal diameter of the applicator tip needle is too small with respect to the viscosity of the adhesive to be dispensed, the user must apply too large of a force to the adhesive container to cause the adhesive to be dispensed, which may cause the applicator tip and/or the cap adaptor to detach from the adhesive container or may cause damage to the applicator tip and/or the cap adaptor. Alternately, if the selected diameter of the needle is too large with respect to the viscosity of the adhesive to be dispensed, too much adhesive is dispensed when the force is applied to the adhesive container to dispense the adhesive. A single droplet of adhesive is dispensed when the needle diameter is selected based on the viscosity of the given adhesive. For example, an internal needle diameter of 1.753 mm is selected to dispense an adhesive, such as E-6000® Low Viscosity adhesive manufactured by Eclectic Products, Inc., having a viscosity of 40,000-60,000 centipoise (cp).

The diameter of the applicator tip needle can be selected to be a range of diameters that permit a single droplet of the adhesive to be dispensed. The range of diameters can be in the form of multiple applicator tips having needles of different internal diameters. The size of the single droplet dispensed from the applicator tip can differ based on the internal diameter of the needle of the applicator tip. For example, a first applicator tip has a needle with a first internal diameter and a second applicator tip has a needle with a second internal diameter. Both the first and the second applicator tips can be structured to be attached to the cap adaptor in any of the ways described in this disclosure. The first diameter dispenses an adhesive droplet of a first size and the second diameter dispenses a droplet of a second size that is different than the first size. The force applied to the adhesive container can be the same or a different value to dispense the single droplet from the first applicator tip compared to the second applicator tip.

Such a range of internal diameters of the applicator needle can also correspond to a range of applied forces that cause the single droplet of adhesive to be dispensed from the applicator tip, in some examples. The range of internal diameters prevents the applicator tip from detaching from the cap adaptor and the cap adaptor from detaching from the adhesive container when a force is applied to the adhesive container to dispense the adhesive. The internal diameter of the applicator tip needle controls the size of the dispensed droplet of adhesive when a force is applied to the adhesive container. The size of the droplet can be as large as the internal diameter of the exit opening of the applicator tip needle and otherwise can have any suitable diameter that is proportional to the internal diameter of the exit opening.

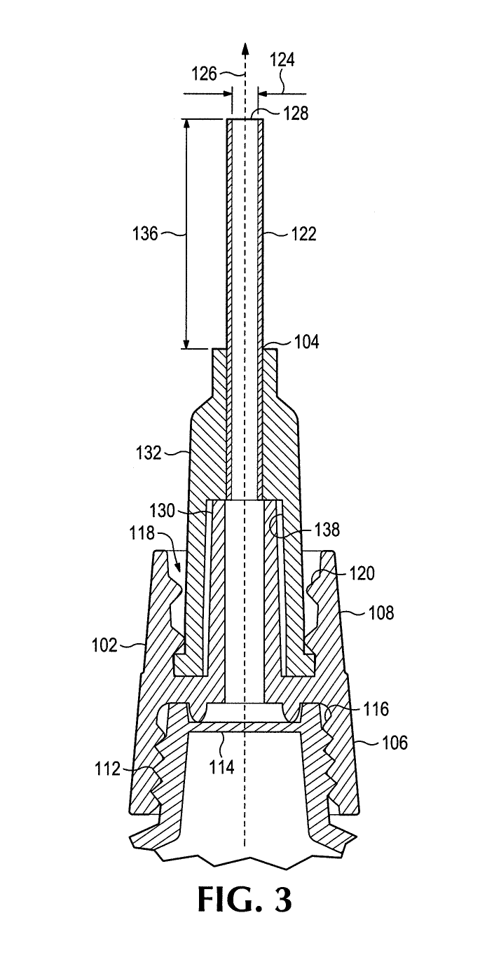

FIG. 2 shows an exploded view of the example adhesive applicator 100 of FIG. 1. The applicator tip 104, cap adaptor 102, and the adhesive container 110 are all shown separated from each other. As discussed above, the adhesive container opening 114 has a threaded collar 112 around its circumference that mates with an internally threaded collar 116 of the first portion 106 of the cap adaptor 102, which can be seen in the cross-sectional view of the adhesive applicator 100 in FIG. 3. The second portion 108 of the cap adaptor 102 has an internally threaded collar 118 and a tube 130 extending away from the first portion 106 opposite the end of the cap adaptor 102 that attaches to the adhesive container opening 114. The tube 130 is positioned centrally within the second portion 108 of the cap adaptor 102 and also extends centrally through the first portion 106, which is shown in the cross-sectional view of FIG. 3. The tube 130 provides the adhesive pathway 126 through the cap adaptor 102 through which the adhesive travels between the adhesive container opening 114 and the applicator tip 104 as the adhesive is dispensed. The cap adaptor 102 and its tube 130 are shown to be round in FIGS. 2 and 3, although they could be other suitable shapes in alternative embodiments.

The applicator tip 104 has a cap adaptor portion 132 and the needle 122 that are secured together in any suitable fashion. The needle 122 is stainless steel, in some examples, but can include other suitable materials that prevent clogging, corrosion, or other issues with the needle during use. As shown in FIGS. 2 and 3, the cap adaptor portion 132 of the applicator tip 104 includes a two-start threading 134 that mates with the conical fitting threading 120 of the cap adaptor 102. The applicator tip threading 134 complements the taper of the conical fitting 118 of the cap adaptor 102 to comprise the Luer lock fitting. As shown by the cross-sectional view of FIG. 3, the applicator tip 104 is secured to the conical fitting 118 of the cap adaptor 102 by the Luer lock fitting such that the needle 122 is aligned over the tube 130 of the cap adaptor 102. The applicator tip needle 122 extends the adhesive pathway 126 from the cap adaptor 102 to the exit opening 128 of the applicator tip 104. As discussed above, the internal diameter 124 of the applicator tip needle 122 controls the size of the adhesive droplet dispensed from the applicator tip needle 122 by setting a maximum diameter of the adhesive droplet based on the applicator tip needle internal diameter 124. The needle 122 shown in FIGS. 1-3 is hollow and tubular-shaped with a square end, but can be other suitable shapes, if desired.

The applicator tip needle 122 extends away from the cap adaptor portion 132 of the applicator tip 104 a distance 136 that allows the user to position the applicator tip 104 as desired, such as in a small area, to dispense adhesive to adhere relatively small objects together and/or to apply adhesive in a precise manner to an object. The applicator tip needle may be extendable in some examples so that it extends away from and into a shaft of the cap adaptor portion of the applicator tip. In other examples, such as the embodiments shown in FIGS. 1-3, the applicator tip needle 122 is fixedly attached to the cap adaptor portion 132 of the applicator tip 104, such as by adhesive, molding, or the like.

As discussed above, the internal surface of the conical fitting 118 of the cap adaptor 102 is tapered. Because of the taper of the conical fitting 118, the external surface of the cap adaptor portion 132 of the applicator tip 104 is also tapered so it mates with the tapering of the conical fitting 118 in a way that permits the threading 120 of the conical fitting 118 and the threading 134 of the applicator tip cap adaptor portion 132 to be screwed together. Still further, the tube 130 of the cap adaptor 102 is also tapered in a manner that complements and fits within the shaft 138 of the applicator tip cap adaptor portion 132, as shown in FIG. 3. The tube and the shaft of the applicator cap adaptor portion are not tapered in alternative examples so long as the tube can fit within the shaft.

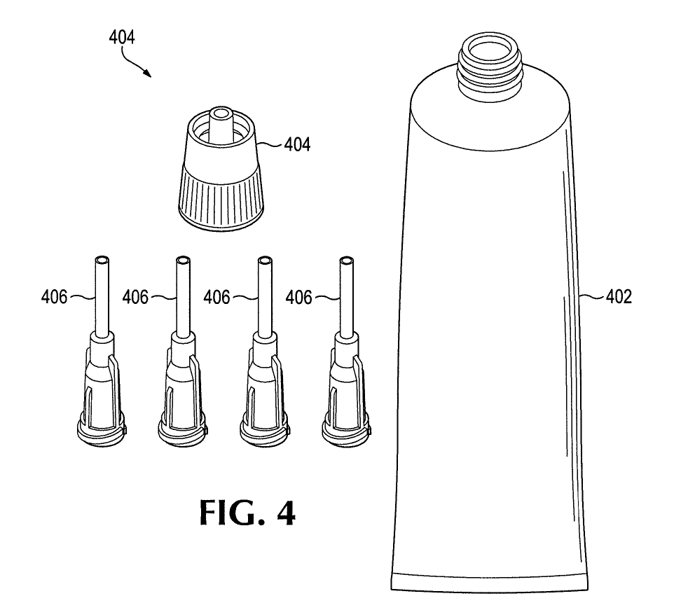

FIG. 4 shows an example adhesive application kit 400 having an adhesive container 402, a cap adaptor 404, and four applicator tips 406. In this example, the four applicator tips 406 are all shown to have the same dimensions, e.g., the same length of the needle, and have applicator tip needles 406 that are the same diameter. Alternative example embodiments may include applicator tip needles with different internal diameters. Other alternative examples of the adhesive application kits have multiple cap adaptors in addition to multiple applicator tips. Any desired number of applicator tips, cap adaptors, and adhesive containers can be included in the disclosed adhesive application kits.

Having described and illustrated the principles of the disclosure in preferred embodiments thereof, it should be apparent that the disclosure can be modified in arrangement and detail without departing from such principles. I claim all modifications and variations coming within the spirit and scope of the following claims.

1. An adhesive applicator, comprising:
a cap adaptor having:
a first portion that is structured to be attached to an opening of an adhesive container, and
a second portion that has a conical fitting with a taper and an internally threaded collar; and
an applicator tip structured to be attached to the conical fitting of the cap adaptor, the applicator tip having a needle with an internal diameter, the needle diameter selected based on a viscosity of the adhesive that is contained in the adhesive container,
wherein the applicator tip is structured to dispense a single droplet of the adhesive upon application of a force to the adhesive container.

2. The adhesive applicator of claim 1, wherein the internally threaded collar of the cap adaptor second portion has a two-start thread.

3. The adhesive applicator of claim 1, wherein the adhesive container includes a metal.

4. The adhesive applicator of claim 1, wherein the applicator tip is removable from the cap adaptor.

5. The adhesive applicator of claim 1, wherein the applicator tip is disposable and replaceable.

6. The adhesive applicator of claim 1, wherein the applicator tip needle includes stainless steel.

7. The adhesive applicator of claim 1, wherein the cap adaptor includes low density polyethylene.

8. The adhesive applicator of claim 1, wherein the internal diameter of the needle is selected based on a maximum applied force to the adhesive container that prevents detachment of the applicator tip from the cap adaptor when the adhesive is dispensed from the adhesive container by application of the force to the adhesive container.

9. The adhesive applicator of claim 1, wherein the internal needle diameter controls a size of the dispensed droplet of adhesive.

10. The adhesive applicator of claim 9, wherein the applicator tip is removable from the cap adaptor.

11. The adhesive applicator of claim 9, wherein the applicator tip is a first applicator tip having a needle with a first internal diameter, and further comprising a second applicator tip structured to be attached to the conical fitting of the cap adaptor, the second applicator rip having a needle with a second internal diameter that is different than the first internal diameter of the first applicator needle, the second applicator tip selected based on the viscosity of the adhesive that is contained in the adhesive container.

12. The adhesive applicator of claim 11, wherein the single droplet is a single droplet dispensed from the first applicator tip needle and having a first droplet size, and wherein the second applicator needle is structured to dispense a single droplet having a second droplet size of the adhesive that is dispensed upon application of the force to the adhesive container, the second droplet size different than the first droplet size.

13. A method of dispensing adhesive from an adhesive container containing an adhesive, comprising:
applying a force to the adhesive container to which an adhesive applicator is attached, the adhesive applicator having:
a cap adaptor having:
a first portion that is structured to be attached to an opening of an adhesive container, and
a second portion that has a conical fitting with an internal taper and an internally threaded collar; and
an applicator tip structured to be attached to the conical fitting of the cap adaptor, the applicator tip having a needle with an internal diameter, the needle diameter selected based on a viscosity of the adhesive that is contained in the adhesive container; and
causing a single droplet of the adhesive to be dispensed from the adhesive container needle.

14. The method of claim 13, further comprising applying the single droplet to an object.

15. The method of claim 13, wherein the applicator tip is a first applicator tip, and further comprising:
removing the first applicator tip from the cap adaptor;
attaching a second applicator tip to the cap adaptor, the second applicator tip structured to be attached to the conical fitting of the cap adaptor and having a second applicator tip internal needle diameter, the second applicator tip needle diameter selected based on the viscosity of the adhesive that is contained in the adhesive container.

16. The method of claim 15, wherein the internal diameter of the first applicator tip needle is the same as the internal diameter of the second applicator tip needle.

17. The method of claim 16, where the first applicator tip and the second applicator tip are disposable.

18. The method of claim 15, wherein the internal diameter of the first applicator tip needle is different than the internal diameter of the second applicator tip needle, and wherein the single droplet of adhesive dispensed from the first applicator needle has a size that is different than a size of the single droplet of adhesive dispensed from the second applicator needle.

19. An adhesive application kit, comprising:
an adhesive applicator, having:
a cap adaptor having:
a first portion that is structured to be attached to an opening of an adhesive container, and
a second portion that has a conical fitting with an internal taper and an internally threaded collar;
a first applicator tip structured to be attached to the conical fitting of the cap adaptor, the first applicator tip having a needle with a first internal diameter, the first needle diameter selected based on a viscosity of the adhesive that is contained in the adhesive container; and
a second applicator tip structured to be attached to the conical fitting of the cap adaptor, the second applicator tip having a needle with a second internal diameter, the second needle diameter selected based on a viscosity of the adhesive that is contained in the adhesive container; and
an adhesive container containing the adhesive,
wherein the first applicator tip and the second applicator tip are disposable and are structured to dispense a single droplet of the adhesive upon application of a force to the adhesive container, and wherein the adhesive applicator and the adhesive container are packaged together as the adhesive application kit.

20. The adhesive application kit of claim 19, wherein the first adhesive applicator and the second adhesive applicator have the same internal diameter.
